(19) United States
(12) Patent Application Publication
(10) Pub. No.: US 2011/0142082 A1
(43) Pub. Date: Jun. 16, 2011

(54) FIBER LASER

(75) Inventors: Min Yong JEON, Daejeon (KR); Kyung Hyun Park, Daejeon (KR); Namje Kim, Daejeon (KR); Young Ahn Leem, Daejeon (KR); Sang-Pil Han, Daejeon (KR); Yongsoon Baek, Daejeon (KR); Jaeheon Shin, Daejeon (KR)

(73) Assignee: ELECTRONIC AND TELECOMMUNICATIONS RESEARCH INSTITUTE, Daejeon (KR)

(21) Appl. No.: 12/908,611

(22) Filed: Oct. 20, 2010

(30) Foreign Application Priority Data
Dec. 11, 2009 (KR) 10-2009-0123357

(51) Int. Cl. H01S 3/30

(52) U.S. Cl. 372/6

(57) ABSTRACT

Provided is a fiber laser generating Terahertz wave. The fiber laser comprises: a light source generating a laser beam as a pump light; first and second resonators first and second resonators first and second resonators resonating the laser beam into first and second wavelengths; and a coupler separating and supplying the laser beam generated in the light source to the first and second resonators and again feeding back the laser beam having the first and second wavelengths resonated respectively in the first and second resonators to the light source.

### CROSS-REFERENCE TO RELATED APPLICATIONS

This U.S. non-provisional patent application claims priority under 35 U.S.C. §119 of Korean Patent Application No. 10-2009-0123357, filed on Dec. 11, 2009, the entire contents of which are hereby incorporated by reference.

### BACKGROUND

The present invention herein relates to a fiber laser, and more particularly, to a fiber laser that can tune two wavelengths.

Since Terahertz wave with a frequency range of 0.1 THz to 3 THz (1 THz=10¹² Hz) is similar to the resonance frequency of molecules of nonmetallic and nonpolar material, Terahertz wave makes it possible to discriminate these molecules in real time by non-destructive, non-opening, or non-contact method. Terahertz wave is on the rise as a technique capable of providing analysis technique of unprecedented new concept in the fields of medicine, medical science, agricultural food, environment measuring, bio, high-tech material evaluation, etc.

Also, Terahertz wave is rapidly widening its applications to various fields. Since Terahertz wave is a very low energy of several meV and does not have an influence on human body, its demand is sharply increasing as an essential core technique for realizing anthropocentric ubiquitous society. However, research and development of a technique for generating Terahertz wave do not catch the demands. For example, a laser generating Terahertz wave does not satisfy real time, portable and low price requirements at the same time.

### SUMMARY

The present disclosure provides a fiber laser that can oscillate a laser beam having two independent wavelengths to generate Terahertz wave.

The present disclosure also provides a fiber laser that can satisfy real time, portable and low price requirements at the same time.

Embodiments of the inventive concept provide fiber lasers comprising: a light source generating a laser beam; first and second resonators first and second resonators resonating the laser beam into first and second wavelengths; and a coupler separating the laser beam generated in the light source to the first and second resonators and feeding back the laser beam having the first and second wavelengths resonated respectively in the first and second resonators to the light source.

In some embodiments, the first and second resonators may comprise second and third optical fibers branched from the coupler, and first and second Bragg gratings respectively connected to the second and third optical fibers.

In other embodiment, each of the first and second Bragg gratings may comprise an optical fiber Bragg grating or a polymer Bragg grating.

In still other embodiments, the first and second resonators may further comprise at least one translator stage straining the first and second Bragg gratings.

In even embodiments, the first and second resonators may comprise first and second stabilizing light sources supplying stabilizing laser beams respectively stabilizing the laser beams having the first wavelength and the second wavelength, and first and second resonant couplers connecting the first and second stabilizing light sources to the second and third optical fibers, respectively.

In yet embodiments, the coupler may comprise any one of a 3 dB coupler, an optical fiber coupler, a waveguide coupler, and a multi mode interference coupler.

In further embodiments, the light source may comprise a first optical fiber connected to the coupler, a pump light source supplying a pump light to the first optical fiber, and an output terminal outputting the laser beams having the first and second wavelengths fed back from the coupler.

In still further embodiments, the light source may comprise a first optical fiber connected to the coupler, and a semiconductor optical amplifier formed in the first optical fiber.

### BRIEF DESCRIPTION OF THE DRAWINGS

The accompanying drawings are included to provide a further understanding of the inventive concept, and are incorporated in and constitute a part of this specification. The drawings illustrate exemplary embodiments of the inventive concept and, together with the description, serve to explain principles of the inventive concept. In the drawings:

FIG. 1 is a diagram illustrating a fiber laser according to an embodiment of the present invention;

FIG. 2 is a graph showing a spectrum of unlocked laser beam; and

FIG. 3 is a graph showing a spectrum of locked laser beam.

### DETAILED DESCRIPTION OF THE EMBODIMENTS

Exemplary embodiments of the present invention will be described below in more detail with reference to the accompanying drawings so that those skilled in the art to which the present invention pertains carry out the technical spirit of the present invention. The invention may, however, be embodied in many different forms and should not be construed as being limited to the embodiments set forth herein; rather, these embodiments are provided so that the present invention will be thorough and complete, and will fully convey the concept of the invention to those skilled in the art.

In the drawings, the thicknesses of layers and regions are exaggerated for clarity. Like reference numerals in the drawings denote like elements throughout.

Meanwhile, for simplicity in description, several embodiments adopting the technical spirit of the present invention will be exemplarily illustrated below, and description for various modified embodiments will be omitted herein. However, those skilled in the art can fully modify and apply the various cases adopting the technical spirit of the present invention based on the detailed description and the exemplary embodiments.

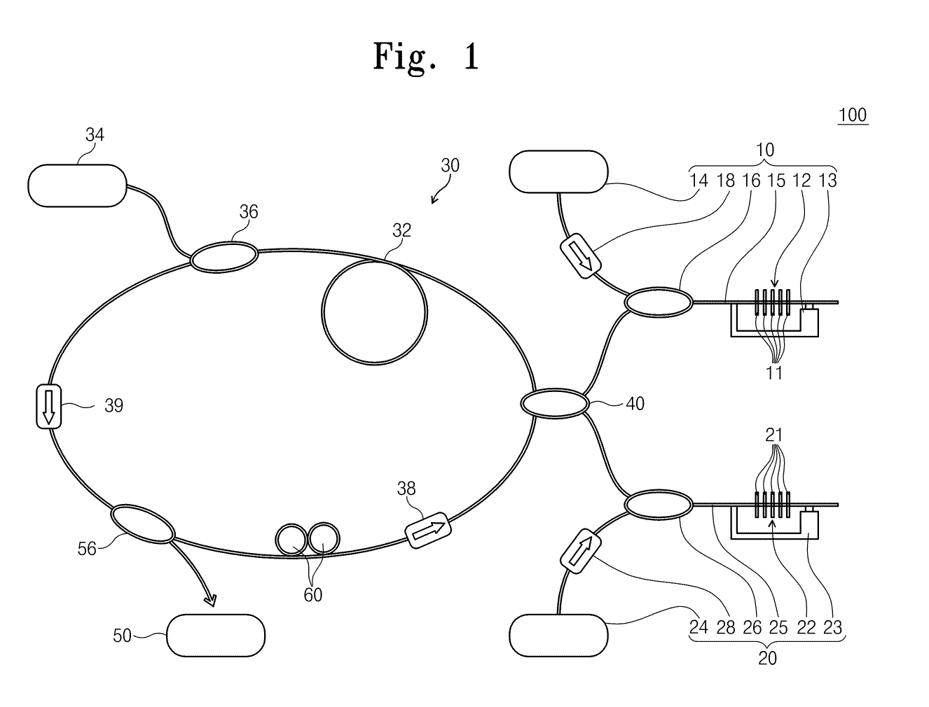

FIG. 1 is a diagram illustrating a fiber laser according to an embodiment of the inventive concept.

Referring to FIG. 1, the fiber laser 100 according to an embodiment of the inventive concept may comprise a laser light source 30 generating a laser beam, and first and second laser resonators 10 and 20 resonating laser beam into first and second wavelengths. A feedback coupler 40 may be disposed between the first and second laser resonators 10 and 20, and the laser light source 30. The feedback coupler 40 may separate and supply the laser beam generated in the laser light source 30 to the first and second laser resonators 10 and 20. Also, the feedback coupler 40 may again provide a feedback of laser beam from the first and second laser resonators 10 and 20 to the laser light source 30. The laser beam having the first wavelength and the second wavelength may be fed back to the laser light source 30 in the feedback coupler 40 and outputted to an output terminal 50. The laser beam having the first and second wavelengths may be beat in a photomixer (not shown) connected to the output terminal 50 to generate Terahertz wave.

Therefore, the fiber laser according to the embodiment of the inventive concept can generate the laser beam having the first and second wavelengths which are independent from each other, the laser beam generating Terahertz wave through the laser light source 30 and the first and second laser resonators 10 and 20. Also, since the fiber laser has a simple structure and uses the beating of the laser beam, the fiber laser satisfying real time, portable and low price requirements can be realized.

The laser light source 30 may comprise a pump light source 34 supplying a pump light, and a first optical fiber 32 generating the laser beam to the pump light source 34. The first optical fiber 32 may comprise a core and a cladding. The core and cladding may be formed of transparent glass material. The core may have a refractive index higher from the cladding. Also, the core may be doped with a gain medium or active medium generating laser beam by using the pump light.

The gain medium or active medium may comprise rare-earth element. The rare-earth element may be excited to a meta-stable state by the pump light and then stabilized to generate laser beam. The rare-earth element may comprise at least one of erbium (Er) and ytterbium (Yb). Erbium (Er) and ytterbium (Yb) may generate laser beam having wave bands of 1550 nm and 1060 nm, respectively. The pump light source 34 may generate pump light exciting the rare-earth element. The pump light source 34 may comprise a 980 nm laser diode. At this time, the gain medium and the pump light source 34 are used for generating laser beam and may be replaced by a semiconductor optical amplifier (not shown).

The first optical fiber 32 and the pump light source 34 may be connected to each other by an input coupler 36. The input coupler 36 may comprise a wavelength division multiplex (WDM) coupler. The input coupler 36 may deliver the pump light to the first optical fiber 32. The pump light may be supplied to the first optical fiber 32 in the direction of a feedback coupler 40. Therefore, the first optical fiber 32 may be connected to the feedback coupler 40 in a direction which the pump light is incident through the input coupler 36. The input coupler 36 and the feedback coupler 40 may be spaced apart by a predetermined distance from each other. If a distance between the input coupler 36 and the feedback coupler 40 increases, the pump light may be sufficiently absorbed in a core of the first optical fiber 32. At this time, if laser beam is generated by a semiconductor optical amplifier, the semiconductor optical amplifier may be formed in the first optical fiber 40 at the position of the input coupler 36.

The first optical fiber 32 may be formed in a circular ring shape or loop shape. The laser beam may resonate in the first optical fiber 32 having the circular ring shape or loop shape. An output coupler 56 may be coupled to a rear end of the input coupler 36 into which the pump light is incident. The output coupler 56 may be again connected to the feedback coupler 40 through the first optical fiber 32. The output coupler 56 may output the laser beam having the first and second wavelengths which are independent from each other, to the output terminal 50. For example, the output coupler 56 may output about 10% of the laser beam having the first and second wavelengths to the output terminal 50.

A first isolator 38 may be disposed in the first optical fiber 32 between the output coupler 56 and the feedback coupler 40. The first isolator 38 may filter the laser beam delivered from the feedback coupler 40 to the output coupler 56. On the other hand, the first isolator 38 may pass the laser beam delivered from the output coupler 56 to the feedback coupler 40. The first isolator 38 may induce the laser beam generated in the first optical fiber 32 from the input coupler 36 to the feedback coupler 40.

A second isolator 39 may be disposed in the first optical fiber 32 between the output coupler 56 and the input coupler 36. The second isolator 39 may pass the laser beam delivered from the input coupler 36 to the output coupler 56. On the other hand, the second isolator 39 may filter the laser beam delivered from the output coupler 56 to the input coupler 36. Therefore, the first and second isolators 38 and 39 may allow the laser beam to deliver in one direction from the first optical fiber 32 having the circular ring shape. Also, a polarization controller 60 controlling polarization of the laser beam may be disposed in the first optical fiber 32. For example, the polarization controller 60 may be disposed in the first optical fiber 32 between the output coupler 56 and the first isolator 38.

The feedback coupler 40 may separate and supply the laser beam generated by the pump light to the first and second laser resonators 10 and 20. Both ends of the first optical fiber 32 formed in the circular ring shape or loop shape may be connected to one point of the feedback coupler 40. The feedback coupler 40 may divide the laser beam at a ratio of 50:50 and supply the divided light beams to the first laser resonator 10 and the second laser resonator 20, respectively. For example, the feedback coupler 40 may comprise a 3 dB coupler, a waveguide coupler, an optical fiber coupler, or a multi mode interference coupler.

The first and second laser resonators 10 and 20 may be formed symmetrically. The first and second laser resonators 10 and 20 may comprise second and third optical fibers 15 and 25 branched from the feedback coupler 40, and first and second Bragg gratings 12 and 22 formed at ends of the second and third optical fibers 15 and 25, respectively. Although not shown in the drawings, the second and third optical fibers 15 and 25 may comprise a core and a cladding. The core and cladding may be formed of transparent glass material. The core may have a refractive index higher than the cladding. Also, the core may be doped with a gain medium or active medium.

The first and second Bragg gratings 12 and 22 may comprise an optical fiber Bragg grating or a polymer Bragg grating. The polymer Bragg grating may expand wavelength varying range of the laser beam compared with the optical fiber Bragg grating. The first and second Bragg gratings 12 and 22 may comprise a plurality of first and second patterns 11 and 21 showing a variation in the refractive index, respectively. The first and second Bragg gratings 12 and 22 may selectively reflect light having a specific wavelength according to a variation in the distance of the plurality of first and second patterns 11 and 21. The first and second Bragg gratings 12 and 22 may adjust distances between the plurality of first patterns 11 and between the plurality of second patterns 21 by first and second translator stages 13 and 23, respectively.

For example, the first translator stage 13 may strain or expand the first Bragg grating 12 to thus increase the distance between the plurality of first patterns 11. The first Bragg grating 12 may resonate the laser beam having the first wavelength corresponding to the distance between the plurality of first patterns 11. Likewise, the second translator stage 23 may adjust the distance between the second patterns 21 of the second Bragg grating 22. The second Bragg grating 22 may resonate the laser beam having the second wavelength corresponding to the distance between the plurality of second patterns 21. Therefore, the first and second Bragg gratings 12 and 22 may allow the laser beams having the first and second wavelengths ranged from about 1530 nm to about 1550 nm to resonate individually in the optical fiber doped with Yb.

The laser beams resonating at the first and second wavelengths in the first and second Bragg gratings 12 and 22 may be locked by at least one stabilizing laser beam. The first and second laser resonators 10 and 20 may comprise stabilizing laser light sources 14 and 24 generating the stabilizing laser beam.

The first and second stabilizing laser light sources 14 and 24 may be respectively coupled to second and third optical fibers 15 and 25 by first and second resonant couplers 16 and 26. Also, third and fourth isolators 18 and 28 may be disposed between the first resonant coupler 16 and the first stabilizing laser light source 14 and between the second resonant coupler 26 and the second stabilizing laser light source 24. The third and fourth isolators 18 and 28 may protect the first and second stabilizing light sources 14 and 24 from the laser beam having the first wavelength and the laser beam having the second wavelength. The first and second stabilizing laser light sources 14 and 24 may comprise a Fabry-Perot Laser Diode (FP-LD). The Fabry-Perot laser diode may generate a stabilizing laser beam capable of generating amplified spontaneous emission.

The stabilizing laser beam is injected into the second and third optical fibers 15 and 25, and the laser beam having the first wavelength and the laser beam having the second wavelength are locked in the second and third optical fibers 15 and 25. That is, the stabilizing laser beams supplied from the first and second stabilizing laser light sources 14 and 24 may have the first and second wavelengths which are the same as those of the laser beams resonated in the first and second Bragg gratings 12 and 22.

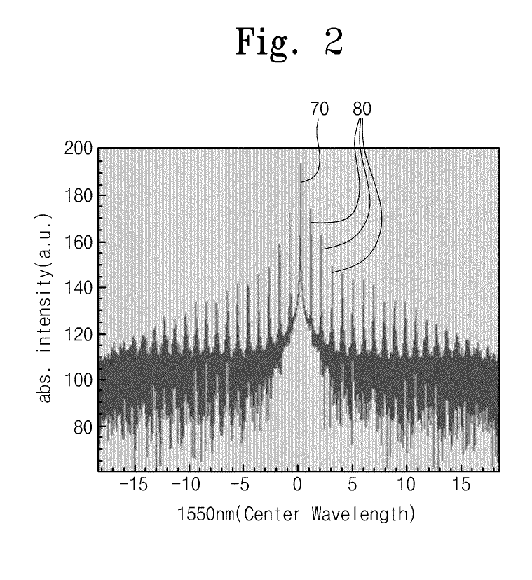

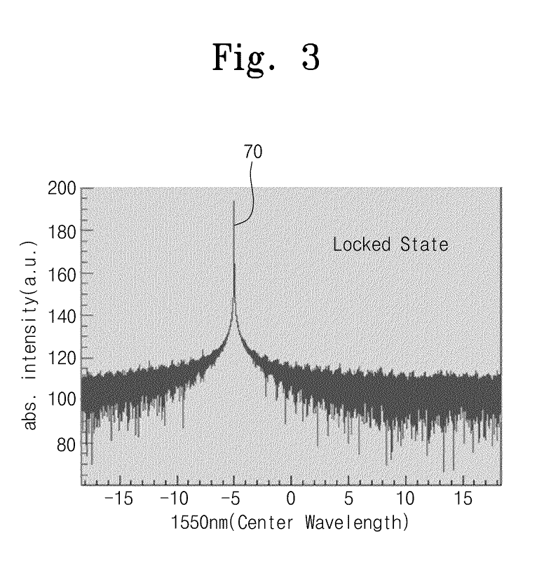

FIGS. 2 and 3 are graphs showing a spectrum of unlocked laser beam and a spectrum of locked laser beam, respectively. In the unlocked laser beam shown in FIG. 2, several peaks appear, whereas in the locked laser beam shown in FIG. 3, only a single peak appears. Herein, a horizontal axis of the graphs indicates a wavelength variation on the center wavelength of 1550 nm, and a vertical axis indicates absorption intensity of laser beam. Also, the peaks appearing in the graphs may be divided into a main mode 70 and a sub mode 80.

The unlocked laser beam may have the plurality of sub-modes 80 around the main mode 70. Since the unlocked laser beam has a wide band spectrum comprising the main mode 70 and the sub-modes 80, the unlocked laser beam does not participate in the generation of Terahertz wave. The locked laser beam may be attenuated such that the sub modes 80 except for the main mode 70 do not appear. Since the locked laser beam has a narrow band spectrum of the main mode 70, the locked laser beam may participate in the generation of Terahertz wave. In the locked laser beam, it can be seen that the main mode 70 is positioned at the center wavelength of 1545 nm.

Therefore, the fiber laser according to the embodiment of the inventive concept may generate Terahertz wave with the locked laser beams having the first and second wavelengths. Terahertz wave may have a frequency (Δf) corresponding to a wavelength difference (Δλ) between the main modes 70 of the laser beams having the first wavelength and the second wavelength. For example, the first laser resonator may allow the locked laser beam the main mode of which has the first wavelength of 1545 nm to resonate. Also, the second laser resonator may allow the locked laser beam the main mode of which has the first wavelength of 1555 nm to resonate. The wavelength difference between the main modes 70 of the laser beams having the first and second wavelengths may be 5 nm. Terahertz wave may be generated at a frequency ranged from about 0.8 THz to about 1 THz.

Meanwhile, the second and third optical fibers 15 and 25 may be connected to the other ends of the feedback coupler 40 to which both ends of the first optical fiber 32 are connected. The feedback coupler 40 may feed back the laser beams having the first and second wavelengths to the laser light source 30. Terahertz wave which can be obtained by beating at the rear end of the output terminal 50 may have a frequency (Δf) which is tunable according to the wavelength difference (Δλ) between the first wavelength and the second wavelength of the laser beam. The frequency (Δf) of Terahertz wave may be tunable in proportional to the difference (Δλ) between the first wavelength and the second wavelength of the laser beam. For example, when the difference (Δλ) between the first wavelength and the second wavelength is 2 nm, 8 nm, and 16 nm, Terahertz waves having frequencies of about 0.1 THz, 1 THz, and 4 THz may be generated. Therefore, Terahertz wave may have the highest frequency when the different (Δλ) between the first wavelength and the second wavelength is maximum.

The first and second laser resonators 10 and 20 may tune the first and second wavelengths of the laser beams resonated through the first and second Bragg gratings 12 and 22. When the first and second wavelengths of the laser beams are tunable, the frequency of Terahertz wave may be changed.

Accordingly, the fiber laser according to the embodiment can allow Terahertz wave the frequency of which is tunable to be generated by individually changing the first and second wavelengths of the laser beam resonated in the first and second laser resonators 10 and 20.

According to the embodiments of the inventive concept, the fiber lasers can generate a laser beam having two independent wavelengths that can generate Terahertz wave through a laser light source and first and second resonators.

Also, since the fiber lasers have a simple structure and use interference of the laser beam, the fiber lasers satisfying real time, portable and low price requirements can be realized.

The above-disclosed subject matter is to be considered illustrative and not restrictive, and the appended claims are intended to cover all such modifications, enhancements, and other embodiments, which fall within the true spirit and scope of the inventive concept. Thus, to the maximum extent allowed by law, the scope of the inventive concept is to be determined by the broadest permissible interpretation of the following claims and their equivalents, and shall not be restricted or limited by the foregoing detailed description.

What is claimed is:

1. A fiber laser comprising:
a light source generating a laser beam;
first and second resonators resonating the laser beam into first and second wavelengths; and
a coupler separating the laser beam generated in the light source to the first and second resonators and feeding back the laser beam having the first and second wavelengths resonated respectively in the first and second resonators to the light source.

2. The fiber laser of claim 1, wherein the first and second resonators comprise second and third optical fibers branched from the coupler, and first and second Bragg gratings respectively connected to the second and third optical fibers.

3. The fiber laser of claim 2, wherein each of the first and second Bragg gratings comprises an optical fiber Bragg grating or a polymer Bragg grating.

4. The fiber laser of claim 2, wherein the first and second resonators further comprise at least one translator stage straining the first and second Bragg gratings.

5. The fiber laser of claim 2, wherein the first and second resonators comprise first and second stabilizing light sources supplying stabilizing laser beams respectively stabilizing the laser beams having the first wavelength and the second wavelength, and first and second resonant couplers connecting the first and second stabilizing light sources to the second and third optical fibers, respectively.

6. The fiber laser of claim 5, wherein the first and second stabilizing light sources comprise a Fabry-Perot laser diode.

7. The fiber laser of claim 5, further comprising first and second isolators respectively formed between the first stabilizing light source and the first resonant coupler and between the second stabilizing light source and the second resonant coupler.

8. The substrate heating unit of claim 1, wherein the coupler comprises any one of a 3 dB coupler, an optical fiber coupler, a waveguide coupler, and a multi mode interference coupler.

9. The substrate heating unit of claim 1, wherein the light source comprises a first optical fiber connected to the coupler, a pump light source supplying a pump light to the first optical fiber, and an output terminal outputting the laser beams having the first and second wavelengths fed back from the coupler.

10. The substrate heating unit of claim 9, wherein the light source further comprises an input coupler coupling the pump light source and the first optical fiber, and an output coupler coupling the output terminal and the first optical fiber.

11. The fiber laser of claim 10, wherein the first optical fiber is formed in a circular ring shape connecting the output coupler, the input coupler and the coupler.

12. The fiber laser of claim 11, wherein the light source further comprises at least one isolator filtering the pump light delivered from the input coupler to the output coupler in the optical fiber.

13. The fiber laser of claim 1, wherein the light source comprises a first optical fiber connected to the coupler, and a semiconductor optical amplifier formed in the first optical fiber.
